(19) United States
(12) Patent Application Publication
(10) Pub. No.: US 2003/0173043 A1
(43) Pub. Date: Sep. 18, 2003

(54) Method for calendering tissue paper

(76) Inventor: Pekka Koivukunnas, Jarvenpaa (FI)

Correspondence Address: LATHROP & CLARK LLP, 740 REGENT STREET SUITE 400, P.O. BOX 1507, MADISON, WI, 537011507

(21) Appl. No.: 10/332,187

(22) PCT Filed: Jul. 5, 2001
(86) PCT No.: PCT/FI01/00643

(30) Foreign Application Priority Data
Jul. 10, 2000 (IT) 20001637

(51) Int. Cl. B31F 1/12; D21F 11/00

(52) U.S. Cl. 162/111; 162/206

(57) ABSTRACT

The invention concerns a method for calendering tissue paper. In the method, the tissue paper is calendered in at least one calendering nip. The tissue paper is calendered in at least one soft, long calendering nip.

The invention concerns a method as defined in the introductory part of claim 1.

Tissue papers contain various sub-grades of silk and tissue papers, such as toilet papers, facial tissues, handkerchief tissues, napkin tissues and wipe-off papers, including e.g. industrial towels, towel papers for use in the kitchen and other towel papers. As is known in the state of the art, tissue papers are conventionally calendered in calendars with a hard nip. The main purpose of calendering is to control the CD (cross direction) thickness. Calendering is performed at very low loads and at a low temperature. In tissue making, calenders are also used in order to bring together the various layers of multi-layer tissue papers before rolling. In connection with the manufacture of some tissue paper grades it has been known to use soft calendering in the calendering of tissue paper, whereby the calendering takes place in a calendering nip, where at least one roll is a so-called soft roll.

U.S. Pat. No. 5,980,691 presents a soft tissue paper with a high density and a method for its manufacture. This publication makes known calendering of a tissue paper web in the calendering nip in such a way that a tissue paper is obtained, the evenness or uniformity of which is less than or equal to 800 microns. In this publication, such a calendering nip is used in the calendering, wherein one roll or both rolls are of steel, surface-coated with rubber, fabric or paper. One roll or both rolls are kept at a temperature, which is optimum for the useful life of the roll in order to prevent overheating of the roll.

As regards the state of the art relating to the invention, reference is also made to Patent Publication WO-9923305, which presents a belt calender, wherein the nip is formed in between the belt and the roll. The belt material used in belt calenders is usually considerably softer than the surface material of soft rolls used in soft calenders.

As is known, the belt material of belt calenders is about ten tines softer than the softest surface-coatings of rolls, and it is known in the state of the art that by soft calendering it is possible to achieve significant advantages compared with hard-nip calendering, which is the most commonly used method at present. It is also known that with some paper and board grades the belt calendering concept gives significant advantages in the paper quality compared with soft calendering than soft calendering gives compared with hard-nip calendering. One of the major advantages with board grades is the saving in bulk, since the treatment is very soft and low pressures are used.

As regards the state of the art concerning the invention, reference is also made to Utility Model Publication DE-29902451, which presents a shoe calender, wherein one roll of the calendering nip is formed by a so-called shoe roll to bring about a longer calendering nip.

The invention aims at bringing about a new method for calendering of tissue paper, with which maximum bulkiness and softness of the tissue paper are achieved.

In order to achieve the objective mentioned above and those emerging hereinafter, the method according to the invention is principally characterised by that which is stated in the characterising part of claim 1.

According to the invention, by using a belt calender or a shoe calender maximum bulkiness and softness are achieved in tissue paper calendering.

One basic factor of the invention is that by belt calendering a high crêping effect is achieved when a so-called post-nip contact is used. This means that the web and the belt are in contact with the thermo roll even after the nip, whereby the belt tension will press the web against the surface of the thermo roll and hereby the belt expands in the nip, and when it is then restored it will crêpe the paper. In this manner a soft tissue paper with maximum bulkiness is brought about.

In accordance with the invention, the shoe calender concept may also be optimised for use in the tissue paper manufacturing process. The shoe is of a convex shape and the neutral axis of the belt is always at a distance from the belt surface. Thus, in reality the outmost belt surface is being compressed as it ravels through the nip, and when the paper web is passed through the shoe nip on the belt of the shoe roll, it too is being compressed in the machine direction, that is, it is forced to become shorter, whereby a crêping effect is achieved. By controlling the calendering paper parameters and the belt tension after the nip, a permanent state of compression (that is, a crêping effect) can be brought about in the web. In this manner softness and bulkiness are brought about in the tissue paper, whereby the paper will also feel softer.

Calendering parameters preferably used in connection with the invention are e.g. a pressure of 5 MPa and a nip length of 20-500 mm.

In the method according to the invention, it is easier to control low pressures than in traditional solutions, because a long calendering nip is used. According to the invention, very low calendering pressures are preferably used in the calendering of tissue paper, which makes for added softness and bulkiness.

In the method according to the invention, such a long nip is used in tissue paper calendering, which is achieved by using a belt calender or a shoe calender, whereby the nip length is 20-500 nm preferably 25-275 nm. According to the invention, the belt material is also soft and its hardness is 80-100 ShA.

1. Method for calendering tissue paper, in which method the tissue paper is calendered in at least one soft, long belt calendering nip which is formed between a belt and a thermo roll, characterised in that in the method the tissue paper is calendered in the belt calendering nip in such a way that the web to be calendered and the belt are kept in contact with the thermo roll of the calendering nip over a distance of 10-200 mm after the nip, and that in the method a belt tension of 1-10 kN/m is used in the belt calender, whereby the belt tension will press the web against the surface of the thermo roll, and hereby the belt expands in the nip, and when the belt is then restored it will crêpe the paper.

2. Method according to claim 1, characterised in that in the method the tissue paper is calendered at low pressures of 0.05-5.0 MPa, preferably 0.05-1.0 MPa.

3. Method according to claim 1 or 2, characterised in that in the method a belt tension is used in the belt calender, which is 5-7 kN/m.

4. Method according to any one of claims 1-3, characterised in that in the method a calendering parameter is used in the belt calender, which is a temperature of <150°.
